(19) United States
(12) Patent Application Publication
(10) Pub. No.: US 2011/0006487 A1
(43) Pub. Date: Jan. 13, 2011

(54) FLAT SEAL

(76) Inventor: Rolf Prehn, Wipperfurth (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/865,275

(22) PCT Filed: Dec. 6, 2008
(86) PCT No.: PCT/DE08/02048

§ 371 Date: Jul. 29, 2010

(30) Foreign Application Priority Data
Jan. 30, 2008 (DE) 102008006676.1

(51) Int. Cl. F02F 11/00; B26D 1/06

(52) U.S. Cl. 277/592; 83/13

(57) ABSTRACT

The invention relates to a flat seal, especially a seal on the exhaust gas side for an internal combustion engine. Said seal is constituted of at least one monolayer sealing element that has a recess, said sealing element consisting of a high-grade, especially high-temperature resistant, metal material, and of a support element receiving the sealing element, said support element consisting of a lower-grade metal material, the support element receiving and guiding the sealing element in such a manner that the sealing element can be fastened and mounted.

The invention relates to a flat gasket, in particular to an exhaust-side gasket for an internal combustion engine.

Metal gaskets are being used today for seals of this kind. The selection of material for such a gasket is based on the highest temperature, or the temperature of continuous operation, respectively. Due to the fact that modern driving mechanisms and motors have increasingly more stringent requirements with respect to the sealing technology and since both the combustion pressures and combustion temperatures are constantly increasing, ever higher-quality materials have to be used in order to satisfy these requirements.

In EP 0 955 489 B1, a metal gasket with different surface pressure areas is described, which contains a first, a second and a third metal plate, whereby the first and the second metal plates have beaded areas and the third metal plate is operatively connected to the first and the second metal plates by means of beading over an internal area.

JP 02286859 A describes a cylinder-head gasket with locking elements for accommodating inserts in the area of the middle clearance hole.

The objective of the invention is to provide a flat gasket, in particular an exhaust-side gasket for internal combustion engines, in which, by optimization of the applied materials, on the one hand, a price reduction compared to the traditional flat gaskets is ensured, and on the other hand a simpler constructive design is achieved.

This objective is achieved by means of a flat gasket, in particular an exhaust-side gasket for an internal combustion engine, built by a sealing element having at least one layer and provided with a recess, said sealing element consisting of high-quality, in particular very temperature-resistant metallic material, as well as of a carrier element accommodating the sealing element and made of low-grade metallic material, wherein the carrying element accommodates and guides the sealing element in such a way that the sealing element can be fixed and mounted.

Further advantageous embodiments of the subject matter of the invention are indicated in the dependent claims.

Therefore, with the subject matter of the invention a kind of hybrid solution consisting of two different materials is created, wherein only the relatively narrow sealing area, which is subjected to high temperatures only, is built by a sealing element made of very high-quality temperature-resistant material. In the carrier element for this sealing element, a metal sheet of considerably less expensive material can be used, which basically serves only to implement the respective layer thickness, to connect, if necessary, several sealing elements one to the other and to form the entire gasket in a manner so as to be fixed and mounted.

By means of a specific combination of suitable materials, it is possible to achieve a considerable cost-effective advantage compared to the solutions used until now, so that now the entire gasket need not be made anymore of high-quality materials but only the materials that are partially used in the sealing area.

The connection between the sealing element and the carrier element is achieved advantageously on a mechanical basis by means of interlocking.

A flat gasket according to the invention can be advantageously used as exhaust flange sealing.

In addition, a method for manufacturing of a flat gasket is proposed, wherein one, at least one-ply sealing element with a predefined contour is punched out so that one single carrier element or several elements, which are connected to one carrier element, are punched out, whereby the carrier element has a punch hole and on the side of the sealing element studs are stamped from the sealing element or elements, so that the studs are at least partially expanded, so that the sealing element is applied individually on the studs or on the carrier element, respectively, and that additional studs are reformed to create a snap connection in the direction of the sealing element.

This type of mechanical connection can be easily produced and can be created with the technologies currently available on the market.

With the help of a corresponding pressing operation, the studs can function as additional sealing means. They can, for example, be used for micro-sealing when certain material, which is soft enough and can flux, is used as a carrier metal sheet. The studs can serve also as stopper elements insofar as the material of the carrier metal sheet is sufficiently strong or rigid. Another advantage of the clamping with such studs is that the thermal conduction or the heat dissipation, respectively, can be configured to the number and the shape of the studs. In this way it is possible to combine very different materials with very different temperature ranges with each other.

In addition, by using this type of clamping it is possible to determine whether and how much clearance (radial clearance) there is or has to be between the sealing element and the carrier element. In this way, differences between the thermal expansion and thermally conditioned stresses associated therewith can be balanced for both materials.

In particular, Ni—Cr—Fe alloys are suitable as materials for the sealing element, whereby other temperature-resistant alloys can also be used. The carrier element can consist of commercially available steel, e.g. cold-rolled strip.

The subject matter of the invention is presented in the figures below by means of one design embodiment and is described as follows. The figures show the following:

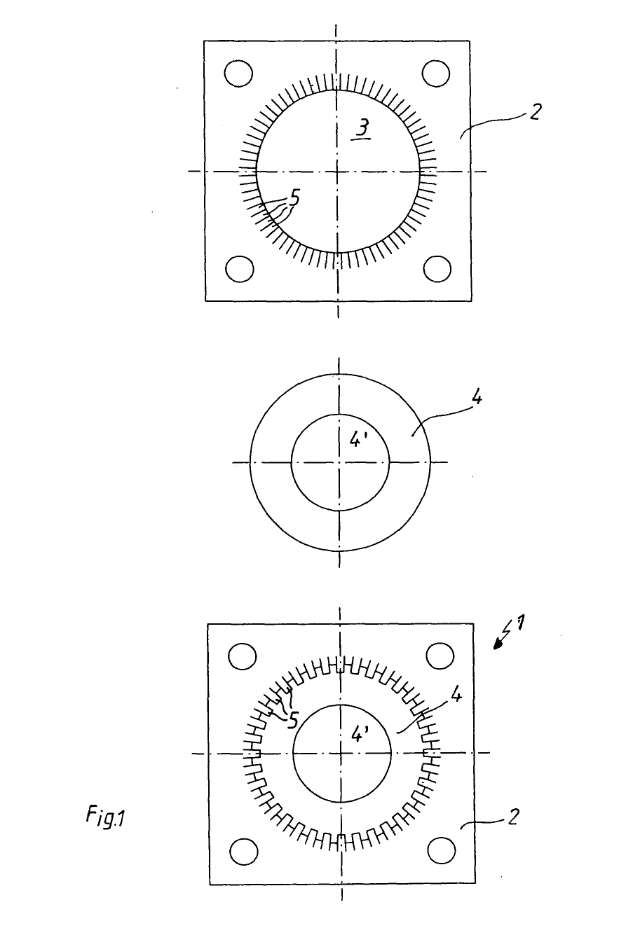

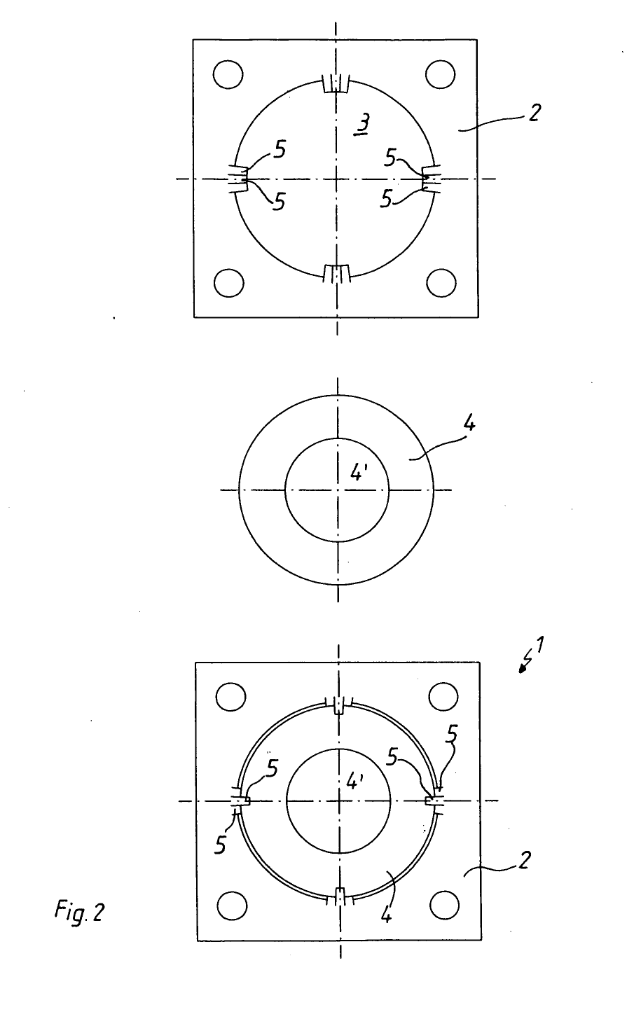

FIGS. 1 and 2—the basic design of the flat gasket according to the present invention consisting of a carrier element and a sealing element;

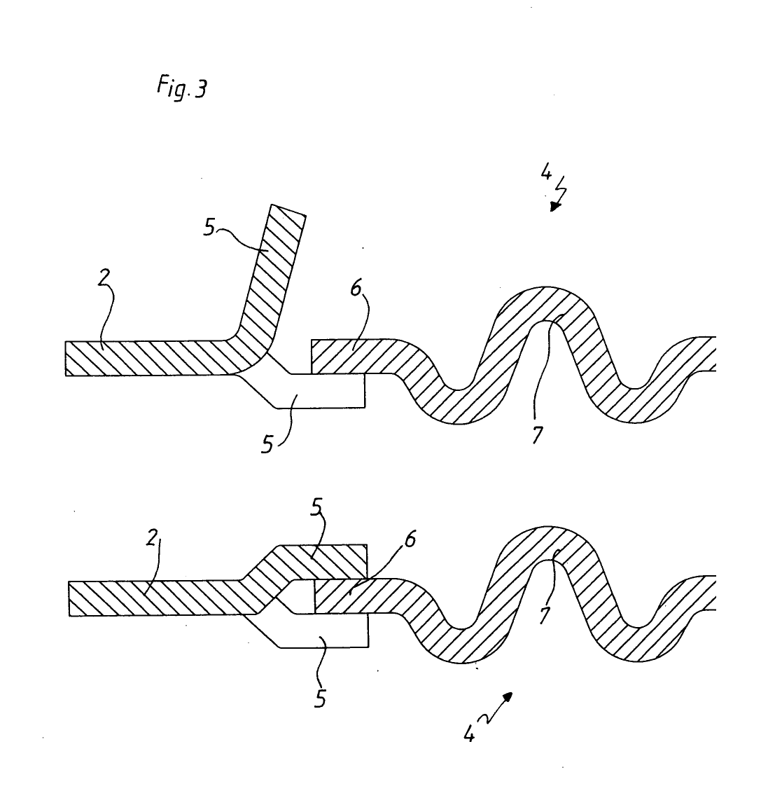

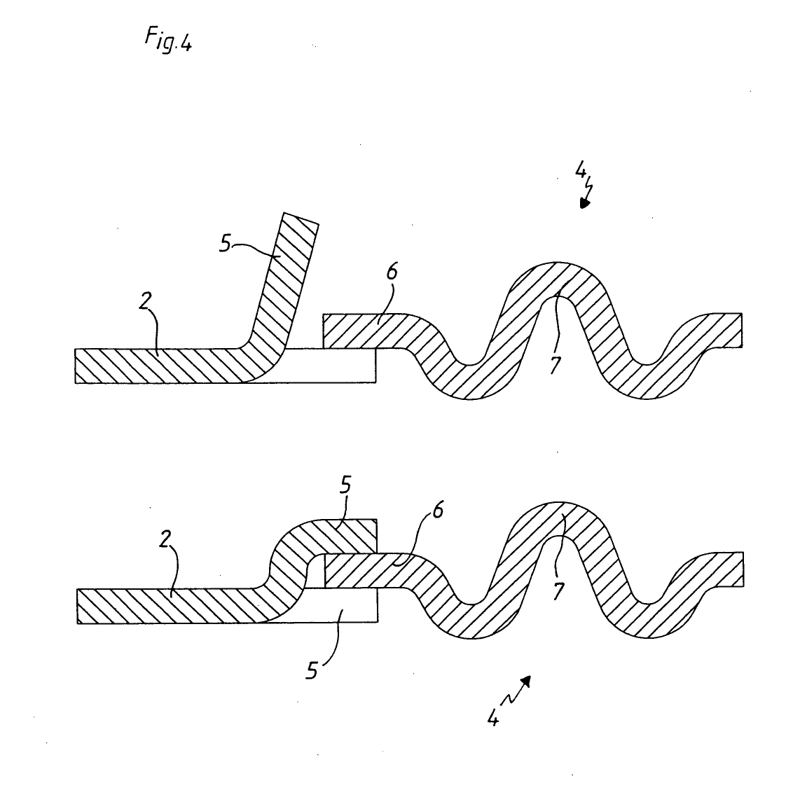

FIGS. 3 and 4—cross sections through variants of the connection between the carrier element and the sealing element;

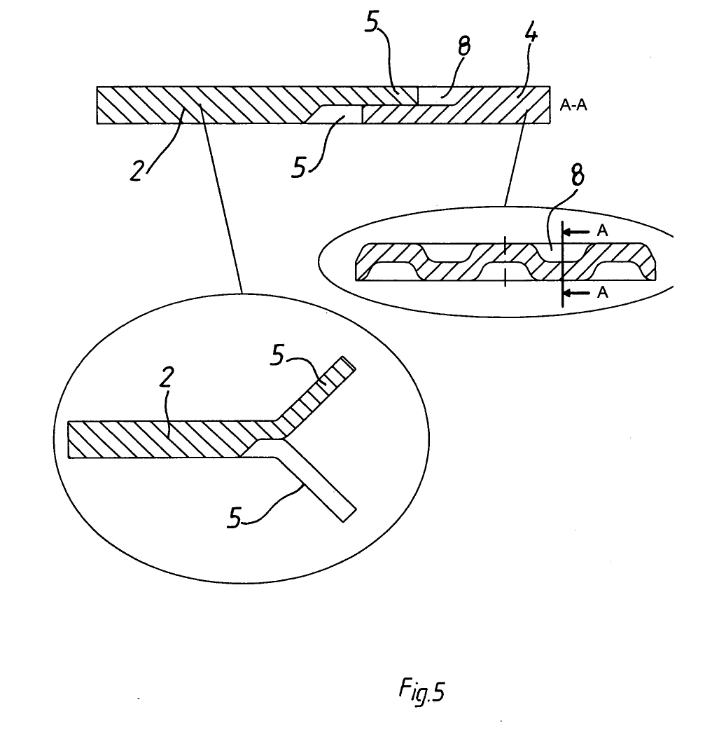

FIG. 5—alternative design embodiment to FIGS. 3 and 4;

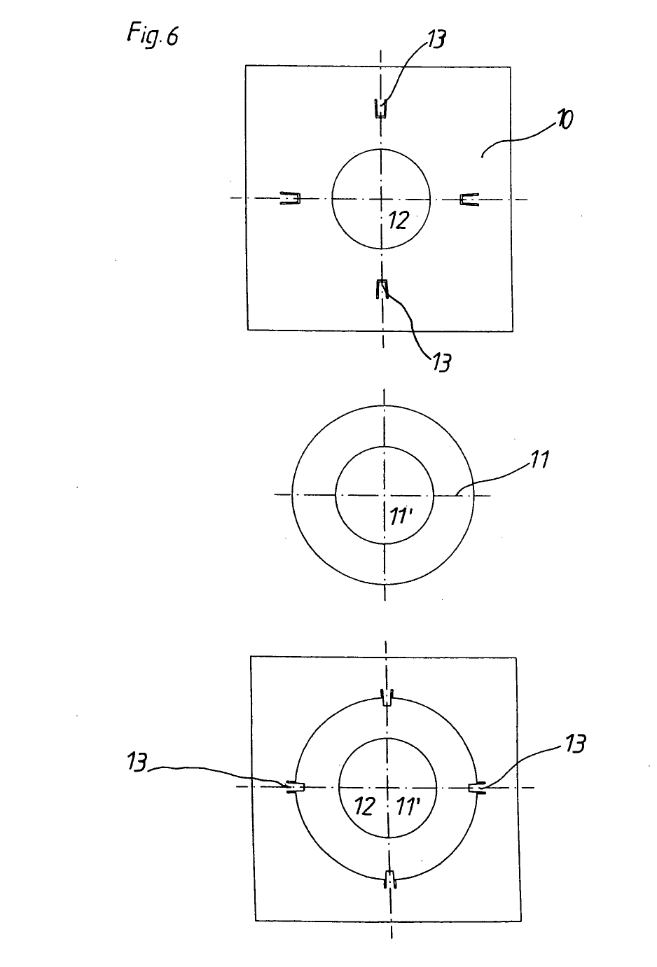

FIG. 6—alternative design embodiment to FIGS. 1 and 2.

FIGS. 1 and 2 show alternative embodiments of the flat gasket 1 as exhaust flange gasket according to the present invention. The same components are designated with the same reference symbols. A carrier element 2 consisting, for example, of a cold-rolled strip with a punch hole 3, is visible therein. Within this punch hole 3 there is a sealing element 4 containing a recess 4′, with said element being guided and mechanically connected by means of a snap-action connection with the carrier element 2 through the studs 5 (which are only indicated) and formed from the carrier element 2. The studs 5 are expanded in the opposing direction, so that some of them are positioned above and others below the sealing element 4. In this example, the sealing element 4 consists of temperature-resistant Ni—Fe—Cr alloy and is guided within the punch hole 3 of carrier element 2 in such a way that it can be easily fixed and mounted.

FIGS. 3 and 4 show cross sections with connection variants between carrier element 2 and sealing element 4. The expanded studs 5, as well as the free leg 6 of sealing element 4, which first is sitting on the lower stud 5 of carrier element 2, are each shown in the top drawing. The bottom drawing of FIGS. 3 and 4 shows the state in which the upper studs 5 were reformed and thus guide the leg 6 between them and maintain it in a clamped position. The sealing element 4 is provided with a beaded area 7 outside of the free leg 6.

Both the carrier element 2 and the sealing element 4 are stamped from suitable plate-like primary products, whereby the punch hole 3 of the carrier element 2 corresponds to the outside perimeter of the elongated sealing element 2. In addition, the studs 5 are stamped out on the side of the punch hole and are expanded in the opposite direction. The sealing element 2 is mounted on the individual bottom studs 5 and then the top studs 5 are reformed in the direction of sealing element 2, so that it—as can be seen in FIGS. 3 and 4 rests on the free leg 6 of sealing element 4.

FIG. 5 shows an embodiment that is an alternative to FIGS. 3 and 4. In FIGS. 3 and 4, material protrusions are formed by the studs 5 axially outside of the leg 6.

FIG. 5 shows an embodiment in which the studs 5 of carrier element 2 and sealing element 4 are positioned in one plane, i.e., the studs 5 are inserted in the radial recesses 8 of sealing element 4.

FIG. 6 shows an embodiment of a flat gasket 9 which is an alternative form to the one in FIGS. 1 and 2. There are indeed components of the same type, namely a carrier element 10 and a sealing element 11, which, however, are connected in another manner with each other in an operative connection. The carrier element 10 contains a punch hole 12, while the sealing element 11 is provided with a recess 11′. The punch hole 12 and the recess 11′ are designed as coincident. Since, as compared to FIGS. 1 and 2, the sealing element 11 is not positioned within the punch hole of the carrier element provided there, here it is necessary to provide another type of connection. The sealing element 11 is positioned in an aligned form, i.e. concentrically to the punch hole 12. Studs 13 were formed from the solid material of the carrier element 10, which are to be viewed as equivalent to those according to FIGS. 1 and 2, with the difference that there is only one top stud 13, because the radial wall thickness of the sealing element 11 rests upon the carrier element 10.

1. Flat gasket for an internal combustion engine, built by a sealing element having at least one layer of temperature-resistant metallic material and provided with a recess, and including a carrier element accommodating the sealing element and made of a metallic material that is of a lower grade than that of said sealing element, wherein the carrier element accommodates and guides the sealing element in such a way that the sealing element can be fixed and mounted.

2. Flat gasket according to claim 1, wherein the sealing element and the carrier element are mechanically interlocked for fixing and mounting the sealing element to the carrier element.

3. Flat gasket according to claim 1, wherein the carrier element has a punch hole corresponding to the outside perimeter of the sealing element and that the carrier element has on the side of the hole several deformable studs for accommodating and guiding the sealing element.

4. Flat gasket to claim 1, wherein the carrier element has a punch hole, which corresponds to the recess of the sealing element, so that the sealing element rests upon the carrier element and the sealing element is held by deformable studs.

5. Flat gasket according to claim 1, wherein the sealing element is provided with at least one circumferential bead.

6. Flat gasket according to claim 5, including a defined radial clearance between the sealing element and the carrier element that is adjustable.

7. Flat gasket according to claim 1, wherein the sealing element metallic material consists of temperature-resistant Ni—Cr—Fe material.

8. Flat gasket according to claim 7, wherein the carrier element metallic material consists of cold-rolled strip steel.

9. Flat gasket according to claim 1, wherein said flat gasket comprises an exhaust flange seal.

10. Method of manufacturing a gasket in which at least a one-ply sealing element with a predefined contour is punched out so that one single carrier element or several elements, which are connected to one carrier element, are punched out, whereby the carrier element has a punch hole and on one side of the sealing element, studs are stamped from the sealing element or elements, so that the studs are at least partially expanded, so that the sealing element is applied individually on the studs or on the carrier element, respectively, and that additional studs are reformed to create a snap connection in the direction of the sealing element.
